(19) United States
(12) Patent Application Publication
(10) Pub. No.: US 2024/0172768 A1
(43) Pub. Date: May 30, 2024

(54) EDIBLE OIL AND FAT COMPOSITION, METHOD FOR INHIBITING UNPLEASANT TASTE, AGENT FOR INHIBITING UNPLEASANT TASTE, AND METHOD FOR PRODUCING DEEP-FRIED FOOD

(71) Applicant: J-OIL MILLS, INC., Tokyo (JP)

(72) Inventors: Yosuke SAWARAGI, Tokyo (JP); Takehiko SEKIGUCHI, Tokyo (JP); Shinsuke HARUGUCHI, Tokyo (JP); Yukie OBARA, Tokyo (JP); Masami INOUE, Tokyo (JP)

(21) Appl. No.: 18/283,497

(22) PCT Filed: Apr. 20, 2022
(86) PCT No.: PCT/JP2022/018322

§ 371 Date: Sep. 22, 2023

(30) Foreign Application Priority Data
Apr. 28, 2021 (JP) 2021-076254

(51) Int. Cl. A23D 9/007; A23D 9/06; A23L 5/10; A23L 27/00

(52) U.S. Cl. CPC A23D 9/007; A23D 9/06; A23L 5/11; A23L 27/84

(57) ABSTRACT

In the present invention, any unpleasant taste in foods cooked using a chlorophyll-containing oil and fat composition is reduced. The edible oil and fat composition comprises: (A) a chlorophyll including one or more selected from the group consisting of chlorophyll a, pheophytin a, and pyropheophytin a; (B) a heated/processed oil and fat including one or more oils selected from the group consisting of (b1) a first heated oil obtained by heat-treating an unrefined raw oil including one or more oils selected from the group consisting of a pressed oil from an oil and fat material and an extracted oil from the oil and fat material, or an oil and fat that has passed through one or more steps selected from the group consisting of a degumming step, a deacidification step, and a decolorization step in a step for refining the unrefined raw oil, (b2) a roasted oil obtained by pressing or extracting the oil and fat material, which has been roasted, and (b3) a second heated oil obtained by heat-treating an oil and fat containing the oil and fat material and/or a processed product thereof; and (C) an edible oil and fat.

### TECHNICAL FIELD

The present invention relates, e.g., to an edible oil and fat composition used for cooking deep-fried foods, a method for inhibiting unpleasant taste, an agent for inhibiting unpleasant taste, and a method for producing a deep-fried food.

### BACKGROUND ART

When a food ingredient is fried (also referred to hereinafter as oil frying) using an edible oil and fat such as soybean oil or rapeseed oil, the edible oil and fat changes color, inter alia, due to a heating operation or the effects of oxygen or moisture within the food ingredient or the atmosphere. A problem is presented in that when the color of the edible oil and fat changes, the appearance of the fried food is affected.

Patent Document 1 discloses an oil and fat composition for frying in which adding 0.05 mass ppm or more and 2 mass ppm or less of chlorophylls to an edible oil and fat makes it possible to inhibit coloration due to oil frying, etc., inhibit any rise in the anisidine value, and inhibit any decrease in tocopherols.

### RELATED ART DOCUMENTS

### Patent Documents

Patent Document 1: International Publication No. 2019/151009

### DISCLOSURE OF THE INVENTION

### Problems the Invention is Intended to Solve

However, e.g., if a fried food is stored in a hot showcase (also referred to as a warmer) after the food ingredient has been oil-fried using a chlorophyll-containing oil and fat, an unpleasant taste derived from the chlorophyll can develop in the fried food upon passage of an extended period of time after oil frying.

The present invention was contrived in view of the foregoing and addresses the problem of providing an edible oil and fat composition capable of reducing the unpleasant taste of foods cooked using a chlorophyll-containing oil and fat composition, a method for inhibiting unpleasant taste, an agent for inhibiting unpleasant taste, and a method for producing a deep-fried food.

### Means for Solving the Problems

According to a first aspect, the present invention provides an edible oil and fat composition characterized by containing (A) a chlorophyll including one or more selected from the group consisting of chlorophyll a, pheophytin a, and pyropheophytin a; (B) a heated/processed oil and fat including one or more oils selected from the group consisting of (b1) a first heated oil obtained by heat-treating an unrefined raw oil including one or more oils selected from the group consisting of a pressed oil from an oil and fat material and an extracted oil from the oil and fat material, or an oil and fat that has passed through one or more steps selected from the group consisting of a degumming step, a deacidification step, and a decolorization step in a step for refining the unrefined raw oil, (b2) a roasted oil obtained by pressing or extracting the oil and fat material, which has been roasted, and (b3) a second heated oil obtained by heat-treating an oil and fat containing the oil and fat material and/or a processed product thereof; and (C) an edible oil and fat.

According to the edible oil and fat composition of the present invention, even if the composition is a chlorophyll-containing edible oil and fat composition, by including the abovementioned heated/processed oil and fat it will be possible to inhibit any unpleasant taste arising in foods that have been cooked using the edible oil and fat composition, e.g., deep-fried foods made by oil-frying using the edible oil and fat composition, and that have been kept warm using a warmer, etc.

The edible oil and fat composition of the present invention preferably contains 0.05 mass ppm or more and 2.00 mass ppm or less of the (A) chlorophyll and 0.05 mass % or more and 10.0 mass % or less of the (B) heated/processed oil and fat.

In the edible oil and fat composition of the present invention, the mass ratio of the (B) heated/processed oil and fat to the (A) chlorophyll is preferably 1:200-1:250000.

In the edible oil and fat composition of the present invention, the oil and fat material of the (B) heated/processed oil and fat preferably includes one or more materials selected from the group consisting of corn, soybeans, and rapeseed.

The edible oil and fat composition of the present invention preferably includes one or more materials selected from the group consisting of rapeseed oil, soybean oil, corn oil, and palm olein as the (C) edible oil and fat.

In the edible oil and fat composition of the present invention, the (b1) first heated oil has been heat-treated at 120° C. or more, the (b2) roasted oil has been subjected to a roasting treatment at 90° C. or more and 180° C. or less, and the (b3) second heated oil has been subjected to heat treatment under conditions that satisfy formula (1) below, with a heating time of 5 minutes or more and 240 minutes or less at more than 100° C. and 220° C. or less.

85−6000/(270−T)<t<240 (1)

(where T: heating temperature (° C.), and t: heating time (minutes); if 85−6000/(270−T) yields a negative value, “5” is to be used)

According to a second aspect, the present invention provides a method for inhibiting unpleasant taste in a food cooked using a chlorophyll-containing oil and fat composition, characterized in that the method comprises a step in which an edible oil and fat composition containing (A) a chlorophyll including one or more selected from the group consisting of chlorophyll a, pheophytin a, and pyropheophytin a and (C) an edible oil and fat has added thereto and mixed therewith (B) a heated/processed oil and fat including one or more oils selected from the group consisting of (b1) a first heated oil obtained by heat-treating an unrefined raw oil including one or more oils selected from the group consisting of a pressed oil from an oil and fat material and an extracted oil from the oil and fat material, or an oil and fat that has passed through one or more steps selected from the group consisting of a degumming step, a deacidification step, and a decolorization step in a step of refining the unrefined raw oil, (b2) a roasted oil obtained by pressing or extracting the oil and fat material that has been roasted, and (b3) a second heated oil obtained by heat-treating an oil and fat containing the oil and fat material and/or a processed product thereof.

According to the method for inhibiting unpleasant taste of the present invention, even if the composition is a chlorophyll-containing edible oil and fat composition, by adding and mixing the abovementioned heated/processed oil and fat it will be possible to inhibit any unpleasant taste arising in foods that have been cooked using the edible oil and fat composition, e.g., deep-fried foods made by oil-frying using the edible oil and fat composition, and that have been kept warm using a warmer, etc.

According to a third aspect, the present invention provides an agent for inhibiting unpleasant taste in a food cooked using a chlorophyll-containing oil and fat composition, characterized in that the agent contains as an active ingredient (B) a heated/processed oil and fat including one or more oils selected from the group consisting of (b1) a first heated oil obtained by heat-treating an unrefined raw oil including one or more oils selected from the group consisting of a pressed oil from an oil and fat material and an extracted oil from the oil and fat material, or an oil and fat that has passed through one or more steps selected from the group consisting of a degumming step, a deacidification step, and a decolorization step in a step of refining the unrefined raw oil, (b2) a roasted oil obtained by pressing or extracting the oil and fat material, which has been roasted, and (b3) a second heated oil obtained by heat-treating an oil and fat containing the oil and fat material and/or a processed product thereof.

According to the agent for inhibiting unpleasant taste of the present invention, by the addition thereof to a chlorophyll-containing edible oil and fat composition it will be possible to inhibit any unpleasant taste arising in foods that have been cooked using the edible oil and fat composition, e.g., deep-fried foods made by oil-frying using the edible oil and fat composition, and that have been kept warm using a warmer, etc.

According to a fourth aspect, the present invention provides a method for producing a deep-fried food, characterized in that a food ingredient is oil-fried using the abovementioned edible oil and fat composition.

According to the method for producing a deep-fried food of the present invention, by oil-frying a food ingredient using an edible oil and fat composition that contains chlorophyll and also contains the abovementioned heated/processed oil and fat, it makes possible to inhibit any unpleasant taste arising in an obtained deep-fried food that has been kept in a warmer, etc.

### MODE FOR CARRYING OUT THE INVENTION

Preferred embodiments of the present invention are described in detail below.

The edible oil and fat composition of the present invention contains (A) a chlorophyll, (B) a heated/processed oil and fat, and (C) an edible oil and fat.

The (A) chlorophyll includes one or more selected from the group consisting of chlorophyll a, pheophytin a, and pyropheophytin a. Chlorophyll is an organic complex in which a tetrapyrrole ring is coordinated to a metal such as magnesium, copper, or zinc. Chlorophyll exists in many forms such as chlorophyll a, chlorophyll b, etc., depending on the type of tetrapyrrole ring and the substituent to which the tetrapyrrole ring is bonded.

When the metal in chlorophyll is substituted by hydrogen, the result is pheophytin. Thermally decomposed chlorophyll becomes pyropheophytin. In the present invention, the (A) chlorophyll may be one selected from chlorophyll a, pheophytin a, and pyropheophytin a individually or may be two or more used in combination.

The (A) chlorophyll content of the edible oil and fat composition of the present invention may be 0.05 mass ppm or more and 2.00 mass ppm or less, preferably 0.1 mass ppm or more and 2.0 mass ppm or less, more preferably 0.3 mass ppm or more and 1.8 mass ppm or less, and even more preferably 0.3 mass ppm or more and 1.6 ppm or less.

When the (A) chlorophyll content is less than 0.05 mass ppm, it will tend to be more difficult to obtain an adequate effect of inhibiting coloration due to oil-frying, etc., effect of inhibiting an elevation in the anisidine value, or effect of inhibiting any decrease in tocopherols. When the chlorophyll content exceeds 2.00 mass ppm, it tends to become difficult to obtain the effect of inhibiting the unpleasant taste of foods described above by adding the (B) heated/processed oil and fat.

The (A) chlorophyll can be quantified in accordance with the analysis method “Chlorophyll-derived substances” used by the Japan Oilseed Processors Association. Specifically, the amount of chlorophyll in an oil and fat can be calculated by the following formula using absorbances at the maximum wavelength near 680 nm and at the ±40 nm wavelength of the maximum wavelength of the target oil and fat.

$$Chlorophyll [ ppm ] = \frac{A 1 - 1 / 2 ( A 2 + A 3 )}{0.1 \times L} \\ A 1 : Absorbance at \\ maximum absorption wavelength \\ A 2 : Absorbance at maximum \\ absorption wavelength - 40 nm \\ A 3 : Absorbance at maximum \\ absorption wavelength + 40 nm \\ L : Cell length [ cm ] \qquad [ Mathematical formula 1 ]$$

The (B) heated/processed oil and fat contains one or more selected from the group consisting of (b1) a first heated oil obtained by heat-treating an unrefined raw oil including one or more oil selected from the group consisting of a pressed oil from an oil and fat material and an extracted oil from the oil and fat material, or an oil and fat that has passed through one or more steps selected from the group consisting of a degumming step, a deacidification step, and a decolorization step in a step of refining the unrefined raw oil, (b2) a roasted oil obtained by pressing or extracting the oil and fat material that has been roasted, and (b3) a second heated oil obtained by heat-treating an oil and fat containing the oil and fat material and/or a processed product thereof.

The oil and fat material of the (B) heated/processed oil and fat is not particularly limited; examples include plant materials such as soybeans, coconut, palm, rapeseed, rice, corn (corn germ), cottonseed, safflower, sunflower, olive, linseed, peanut, sesame, perilla, pumpkin, and almond. Among the above materials, it is preferable to include one or more selected from the group consisting of corn (corn germ), soybeans, and rapeseed.

The unrefined raw oil used for the (b1) first heated oil may be, e.g., a pressed oil obtained by pressing an oil and fat material or an extracted oil obtained by extracting an oil and fat material. The unrefined raw oil may be, e.g., a mixture of pressed oil and extracted oil.

There is no particular limitation as to the pressing method. For example, pressing can be carried out using an expeller-type press composed of a cylindrically formed casing and a screw that is rotatably provided inside the casing, etc.

Extraction can be carried out by bringing a solvent into contact with an oil and fat material after crushing and compressing or a residue left after press extracting, and distilling off the solvent from the solution obtained by extraction to obtain an oil fraction. Examples of the solvent used in extraction include hexane, etc.

The refining step removes impurities, etc., contained in the unrefined raw oil. The refining step includes, e.g., a degumming step, a deacidification step, a decolorization step, a deodorization step, etc.

The degumming step involves hydrating and removing a gum substance that principally contains a phospholipid contained in the unrefined raw oil. Specifically, in the degumming step, water vapor or water is added to the unrefined raw oil, and the resulting combination is stirred.

The gum substance contained in the unrefined raw oil thereby migrates to the water layer upon being hydrated. Therefore, removing the water layer removes the gum substance from the unrefined raw oil. The degumming step may be performed by adding a degumming agent. It is permissible to use, e.g., a substance composed of an aqueous solution of an organic acid such as oxalic acid, citric acid, or phosphoric acid as the degumming agent.

The deacidification step involves removing free fatty acids contained in the unrefined raw oil as a soap fraction. The deacidification step can be performed, e.g., by treating the unrefined raw oil using an aqueous solution in which an alkaline substance such as sodium carbonate or caustic soda is dissolved in water.

The free fatty acids contained in the unrefined raw oil form a soap due to the abovementioned alkaline aqueous solution. Removing the soap from the unrefined raw oil removes the free fatty acids from the unrefined raw oil.

The deacidification step is not limited to treating the unrefined raw oil using an aqueous solution of an alkali and can also be performed through, e.g., a physical refining method. Examples of the physical refining method include steam distillation and molecular distillation.

The decolorization step involves removing pigments included in the unrefined raw oil. The decolorization step can be performed, e.g., by adsorbing the pigments onto activated clay, activated carbon, etc. The activated clay, etc., to which the pigments have bonded is removed through, e.g., reduced-pressure filtration.

The deodorization step involves removing odoriferous components included in the unrefined raw oil. The deodorization step can be performed, e.g., by carrying out steam distillation under reduced pressure.

In the present embodiment, an “oil and fat that has passed through the degumming step” refers to an oil and fat obtained by subjecting the unrefined raw oil to the degumming step. Also, an “oil and fat that has passed through the deacidification step” refers to an oil and fat obtained by subjecting the unrefined raw oil to the degumming step and the deacidification step. More typically, an “oil and fat that has passed through the deacidification step” may be obtained, e.g., by subjecting the unrefined raw oil to the degumming step and then to the deacidification step.

Furthermore, an “oil and fat that has passed through the decolorization step” refers to an oil and fat obtained by subjecting the unrefined raw oil to the degumming step, deacidification step, and decolorization step. More typically, an “oil and fat that has passed through the decolorization step” may be obtained, e.g., by subjecting the unrefined raw oil to each of the degumming step, deacidification step, and decolorization step in the stated order.

In the (b1) first heated oil, an unrefined raw oil or an oil and fat that has passed through one or more steps selected from the group consisting of the degumming step, deacidification step, and decolorization step in a step of refining the unrefined raw oil is subjected to heat treatment. The heat treatment is performed in a higher temperature range than, e.g., the heat treatment conducted at approximately 100° C. in the refining step for refining the unrefined raw oil. For example, heat treatment is performed at 120° C. or more. The temperature conditions for the heat treatment are preferably 130° C. or more and 220° C. or less, more preferably 130° C. or more and 190° C. or less. Heating under these conditions makes it possible to inhibit any unpleasant taste in foods cooked using an edible oil and fat composition containing the resulting (b1) first heated oil.

In any nonlimiting embodiment of the present invention, the (b1) first heated oil may be used after performing further refining steps after having subjected the unrefined raw oil or an oil and fat that has passed through one or more steps selected from the group consisting of the degumming step, deacidification step, and decolorization step in a step of refining the unrefined raw oil, to heat treatment. In such instances, the same treatments as in a step of refining the unrefined raw oil described above may be performed, or among such treatments, an unimplemented step may be included.

The (b2) roasted oil is obtained by pressing or extracting an oil and fat material that has been roasted. The roasted oil is not particularly limited as long as the roasted oil is a generic variety of roasted oil that can be used in foods.

The oil and fat material used in the (b2) roasted oil is preferably, e.g., corn (corn germ), soybeans, sesame, rapeseed, cottonseed, etc., among the abovementioned oil and fat materials. One of these oil and fat materials may be used individually or two or more may be used in combination in the roasted oil.

The method used for roasting the oil and fat material may be performed using an ordinary roasting means, e.g., a roasting device equipped with a heating means such as electric heat, hot air, a burner, microwaves, etc.

The roasting conditions may be set appropriately in accordance with the embodiment. For example, roasting is preferably conducted at 90° C. or more and 180° C. or less, more preferably 110° C. or more and 180° C. or less, even more preferably 120° C. or more and 180° C. or less, even more preferably 140° C. or more and 180° C. or less, and especially preferably 140° C. or more and 165° C. or less.

As regards the holding time during roasting, e.g., roasting may be ended when a set temperature is reached, preferably 90 minutes or less after reaching the set temperature, more preferably more than 0 minutes and 90 minutes or less after reaching the set temperature, even preferably 3 minutes or more and 90 minutes or less after reaching the set temperature, even more preferably 5 minutes or more and 90 minutes or less after reaching the set temperature, and especially preferably 5 minutes or more and 60 minutes or less after reaching the set temperature. Excessively mild roasting conditions tend to yield an inadequate effect in inhibiting unpleasant taste in foods; excessively harsh roasting conditions tend to result in a burnt odor being produced.

After roasting, the oil and fat material can be removed, e.g., by reduced-pressure filtration, etc.

In any nonlimiting embodiment of the present invention, the (b2) roasted oil may be used after having pressed or extracted the roasted oil and fat material and subsequently subjecting the resultant to the refining step. In such instances, the same treatments as in a step of refining the unrefined raw oil described above may be performed, or among such treatments, an unimplemented step may be included.

The (b3) second heated oil is obtained by adding one or more selected from the group consisting of the abovementioned oil and fat material and processed products of the oil and fat material (also referred to hereinafter as “oil and fat material and/or processed product thereof”) to a base oil and heating under predetermined conditions. Processed products of the oil and fat material include a crushed (cracked) product, strained lees, and heat treatment products of the abovementioned oil and fat material. Preferred as specific examples of processed products of the oil and fat material are cracked soybeans, rapeseed strained lees, cottonseed strained lees, olive strained lees, etc. The processed product of the oil and fat material used may be one of the above individually or a blend of two or more types. “Strained lees” refers to a solid residue obtained after squeezing an oil and fat from an oil and fat material.

The base oil of the (b3) second heated oil is not particularly limited as long as the oil can be used as an edible oil. Concrete examples of the base oil of the (b3) second heated oil include vegetable oils and fats such as corn oil, soybean oil, rapeseed oil (canola oil), cottonseed oil, rice bran oil, sesame oil, olive oil, sunflower oil, perilla oil, linseed oil, peanut oil, safflower oil, palm oil, palm kernel oil, palm ultra-hardened oil, coconut oil, and cocoa butter; animal oils and fats such as fish oil, beef tallow, pork fat, and chicken fat; and synthetic oils and fats such as medium-chain fatty acid triglycerides. Additional examples include processed oils and fats obtained by subjecting these vegetable oils and fats, animal oils and fats, and synthetic oils and fats to one or more types of processing selected from fractionation, hydrogenation, transesterification, etc. Vegetable oils and fats such as corn oil, rapeseed oil, soybean oil, and palm oil are preferred as base oils of the second heated oil. One of the above or a combination of two or more of the above may be used as the base oil of the (b3) second heated oil.

The ration of the total mass of the oil and fat material and/or processed product thereof to the mass of the base oil is preferably 0.05 times or more and 1 times or less, more preferably 0.1 times or more and 1 times or less, and even more preferably 0.4 times or more and 1 times or less.

The heating conditions satisfy formula (1) below, with a heating time of 5 minutes or more and 240 minutes or less at more than 100° C. and 220° C. or less.

85−6000/(270−T)<t<240 (1)

(where T: heating temperature (° C.) and t: heating time (minutes); if 85−6000+(270−T) yields a negative value, “5” is to be used)

In the present embodiment, the heating time refers to the time after reaching more than 100° C. and 220° C. or less. The temperature during the heating time need not be kept constant as long as the temperature is included within the above range. The heating temperature refers to the average temperature after reaching more than 100° C. and 220° C. or less. The heating temperature is more than 100° C. and 220° C. or less, preferably more than 110° C. and 210° C. or less, and more preferably more than 130° C. and 200° C. or less. The heating time is 5 minutes or more and 240 minutes or less, preferably 15 minutes or more and 200 minutes or less, and more preferably 20 minutes or more and 120 minutes or less. By heating the oil and fat material and/or processed product thereof under the above heating conditions, it makes possible to inhibit the unpleasant taste of foods cooked using an edible oil and fat composition containing the (b3) second heated oil obtained.

After heating under the heating conditions described above, the oil and fat material and/or processed product thereof can be removed by, e.g., reduced-pressure filtration, etc.

In any nonlimiting embodiment of the present invention, the (b3) second heated oil may be used after having obtained a heated oil by the abovementioned heat treatment, and subsequently subjecting the resulting heated oil to the refining step. In such instances, the same treatments as in a step of refining the unrefined raw oil described above may be performed, or among such treatments, an unimplemented step may be included.

The edible oil and fat of (C) is not particularly limited; examples include vegetable oils and fats such as corn oil, soybean oil, rapeseed oil (canola oil), cottonseed oil, rice bran oil, sesame oil, olive oil, sunflower oil, perilla oil, linseed oil, peanut oil, safflower oil, palm oil, palm kernel oil, palm ultra-hardened oil, coconut oil, and cocoa butter; animal oils and fats such as fish oil, beef tallow, pork fat, and chicken fat; and synthetic oils and fats such as medium-chain fatty acid triglycerides. Additional examples include processed oils and fats obtained by subjecting these vegetable oils and fats, animal oils and fats, and synthetic oils and fats to one or more types of processing selected from fractionation, hydrogenation, transesterification, etc. The edible oil and fat preferably includes one or more selected from rapeseed oil, soybean oil, corn oil, and palm olein.

The edible oil and fat composition of the present invention may contain the (B) heated/processed oil and fat in a concentration of 0.05 mass % or more and 10.0 mass % or less, preferably 0.05 mass % or more and 8.0 mass % or less, more preferably 0.1 mass % and 8 mass % or less, even more preferably 0.3 mass % or more and 5.0 mass % or less, and even more preferably in specific 0.3 mass % or more and 4.0 mass % or less.

The mass ratio of the (B) heated/processed oil and fat to the (A) chlorophyll may be 1:200-1:250000, preferably 1:300-1:100000, more preferably 1:300-1:50000, even more preferably 1:500-1:50000, and even more preferably in specific 1:600-1:40000.

Additives other than the (A) chlorophyll, (B) heated/processed oil and fat, and (C) edible oil and fat may be added to the edible oil and fat composition of the present invention within a range that does not compromise the effects of the present invention. For example, seasonings, flavorings, spices, colorings, emulsifiers, antioxidants, silicones, etc., may be added to the edible oil and fat composition. Examples of antioxidants include tocopherol, etc.

Meanwhile, according to another aspect, the present invention provides a method for inhibiting unpleasant taste in a food cooked using a chlorophyll-containing oil and fat composition that includes a step for adding and mixing the (B) heated/processed oil and fat with an oil and fat containing (A) a chlorophyll and (C) an edible oil and fat. According to the present invention, it is possible to effectively inhibit any unpleasant taste arising in foods that have been heat-cooked via oil frying, etc., using the edible oil and fat composition, and that have been kept warm using a warmer, etc., even if the composition is a chlorophyll-containing edible oil and fat composition.

According to yet another aspect, the present invention provides an agent for inhibiting unpleasant taste in a food cooked using a chlorophyll-containing oil and fat composition that contains the (B) heated/processed oil and fat as an active ingredient. According to the agent, it is possible to effectively inhibit, even if the composition is a chlorophyll-containing edible oil and fat composition, any unpleasant taste arising in foods that have been heat-cooked via oil frying, etc., using the edible oil and fat composition, and that have been kept warm using a warmer, etc.

According to another aspect, the present invention provides a method for producing a deep-fried food by oil frying a food ingredient using the abovementioned edible oil and fat composition containing (A) a chlorophyll, (B) heated/processed oil and fat, and (C) an edible oil and fat. Specifically, the deep-fried food obtained by the method for producing a deep-fried food of the present invention can inhibit any unpleasant taste in foods that arises when the foods are kept warm using a warmer, etc. Examples of foods to which this method for producing a deep-fried food can be applied include deep-fried foods such as tempura, French fries, hash browns, croquettes, fried chicken, pork cutlet, fried fish, corn dogs, chicken nuggets, fried tofu, donuts, fried bread, fried rice crackers, snacks, and instant noodles.

### EXAMPLES

### Test Example 1

Edible oil and fat compositions were prepared according to the formulations shown in Table 1.

TABLE 1

| | Comparative | Example | Example | Example | Example | Example |
|---|---|---|---|---|---|---|
| | example 1 | 1-1 | 1-2 | 1-3 | 1-4 | 1-5 |
| Edible oil and | 99.9980% | 99.8980% | 99.4980% | 98.9980% | 96.9980% | 94.9980% |
| fat (rapeseed | | | | | | |
| oil) | | | | | | |
| Chlorophyll(s) | 0.0020% | 0.0020% | 0.0020% | 0.0020% | 0.0020% | 0.0020% |
| Heated/processed | — | 0.1000% | 0.5000% | 1.0000% | 3.0000% | 5.0000% |
| oil and fat A | | | | | | |
| Total | 100.0000% | 100.0000% | 100.0000% | 100.0000% | 100.0000% | 100.0000% |
| Chlorophyll(s) | 1.4 | 1.4 | 1.4 | 1.4 | 1.4 | 1.4 |
| [ppm]* | | | | | | |

*Measured value

Deodorized rapeseed oil (manufactured by J-Oil Mills, Inc.), obtained by subjecting rapeseed as the oil and fat material to a degumming step, a deacidification step, decolorization step, and a deodorization step, was used as the edible oil and fat.

Nichino Color G-AO (manufactured by Nichino Kagaku Kogyo Co., Ltd.) containing a total of about 5 mass % of chlorophyll a, pheophytin a, and pyropheophytin a was used as the chlorophyll.

Heated/processed oil and fat A, obtained by subjecting corn (corn germ) as the oil and fat material to a degumming step and deacidification step, subjecting the resultant to heat treating for 2 hours at 120° C., and conducting a decolorization step and deodorization step thereafter, was used as the heated/processed oil and fat.

### (Test of Changes Over Time in Croquettes)

NEW Potato Croquettes 60 (manufactured by Ajinomoto Frozen Foods Co., Ltd.) were oil-fried using 500 g of any of the edible oil and fat compositions.

A hot showcase (model PRO-6WSE; Yasukichi Co., Ltd.) was set to 85° C., and the temperature inside was set at 66° C. The oil-fried potato croquettes were stored for 6 hours in this hot showcase.

### (Evaluation)

The potato croquettes that had been stored for 6 hours in the hot showcase after oil frying were evaluated organoleptically by a five-member panel. The evaluation categories were unpleasant taste, degradation taste, and richness when eating the potato croquettes. The unpleasant taste, degradation taste, and richness were evaluated according to the following criteria, and the average score was taken as the evaluation value. The results are shown in Table 2.

Unpleasant taste: taste of food (potato croquette) derived from odor due to photodegradation of edible oil and fat
5: no unpleasant taste
4: slight unpleasant taste
3: unpleasant taste
2: fairly strong unpleasant taste
1: strong unpleasant taste

Degradation taste: taste of food (potato croquette) derived from edible oil and fat having been degraded by light, oxidation, etc.
5: no degradation taste
4: slight degradation taste
3: degradation taste
2: fairly strong degradation taste
1: strong degradation taste

Richness: richness of food (potato croquette) derived from edible oil and fat
5: strong richness
4: fairly strong richness
3: rich
2: fairly weak richness
1: weak richness

TABLE 2

| | Comparative | Example | Example | Example | Example | Example |
|---|---|---|---|---|---|---|
| | example 1 | 1-1 | 1-2 | 1-3 | 1-4 | 1-5 |
| Edible oil and | 99.9980% | 99.8980% | 99.4980% | 98.9980% | 96.9980% | 94.9980% |
| fat (rapeseed | | | | | | |
| oil) | | | | | | |
| Chlorophyll(s) | 0.0020% | 0.0020% | 0.0020% | 0.0020% | 0.0020% | 0.0020% |
| Heated/processed | — | 0.1000% | 0.5000% | 1.0000% | 3.0000% | 5.0000% |
| oil and fat A | | | | | | |
| Chlorophyll(s) | 1.4 | 1.4 | 1.4 | 1.4 | 1.4 | 1.4 |
| [ppm]* | | | | | | |
| Unpleasant taste | 3.2 | 3.8 | 3.8 | 4.0 | 4.0 | 4.0 |
| Degradation taste | 3.4 | 3.6 | 3.8 | 3.8 | 3.8 | 3.8 |
| Richness | 2.3 | 2.8 | 3.0 | 2.5 | 2.9 | 2.7 |

*Measured value

### (Evaluation of Unpleasant Taste)

As shown in Table 2, the unpleasant taste of potato croquettes oil-fried using edible oil and fat compositions prepared using the formulations of examples 1-1 to 1-5 was more clearly inhibited than with potato croquettes oil-fried using the edible oil and fat composition prepared according to the formulation of comparative example 1. In other words, it was clear that unpleasant taste was inhibited in the examples where a heated/processed oil and fat was added to a greater extent than in the comparative example.

### (Evaluation of Degradation Taste)

As shown in Table 2, the degradation taste of potato croquettes oil-fried using edible oil and fat compositions prepared using the formulations of examples 1-1 to 1-5 was more clearly inhibited than with potato croquettes oil-fried using the edible oil and fat composition prepared using the formulation of comparative example 1.

### (Evaluation of Richness)

As shown in Table 2, potato croquettes oil-fried using edible oil and fat compositions prepared using the formulations of examples 1-1 to 1-5 were clearly richer than potato croquettes oil-fried using the edible oil and fat composition prepared using the formulation of comparative example 1.

### Test Example 2

Edible oil and fat compositions were prepared using the formulations shown in Table 3.

TABLE 3

| | Comparative | Example | Example | Comparative | Example | Example |
|---|---|---|---|---|---|---|
| | example 2-1 | 2-1 | 2-2 | example 2-2 | 2-3 | 2-4 |
| Edible oil and | 99.9995% | 99.9495% | 99.8995% | 99.9990% | 99.9490% | 99.8990% |
| fat (rapeseed | | | | | | |
| oil) | | | | | | |
| Chlorophyll(s) | 0.0005% | 0.0005% | 0.0005% | 0.0010% | 0.0010% | 0.0010% |
| Heated/processed | — | 0.0500% | 0.1000% | — | 0.0500% | 0.1000% |
| oil and fat B | | | | | | |
| Total | 100.0000% | 100.0000% | 100.0000% | 100.0000% | 100.0000% | 100.0000% |
| Chlorophyll(s) | 0.25 | 0.25 | 0.25 | 0.5 | 0.5 | 0.5 |
| [ppm]* | | | | | | |

*Measured value

Heated/processed oil and fat B was used as the heated/processed oil and fat, having been obtained by using corn (corn germ) as the oil and fat material, roasting the corn for 30 minutes at 150° C., pressing the roasted corn, and subjecting the roasted corn oil obtained to a further degumming step, deacidification step, decolorization step, and deodorization step.

A test of the changes over time in croquettes was conducted in the same manner as in test example 1.

TABLE 4

| | Comparative | Example | Example | Comparative | Example | Example |
|---|---|---|---|---|---|---|
| | example 2-1 | 2-1 | 2-2 | example 2-2 | 2-3 | 2-4 |
| Edible oil and | 99.9995% | 99.9495% | 99.8995% | 99.9990% | 99.9490% | 99.8990% |
| fat (rapeseed | | | | | | |
| oil) | | | | | | |
| Chlorophyll(s) | 0.0005% | 0.0005% | 0.0005% | 0.0010% | 0.0010% | 0.0010% |
| Heated/processed | — | 0.0500% | 0.1000% | — | 0.0500% | 0.1000% |
| oil and fat B | | | | | | |
| Chlorophyll(s) | 0.25 | 0.25 | 0.25 | 0.5 | 0.5 | 0.5 |
| [ppm]* | | | | | | |
| Unpleasant taste | 4.2 | 4.4 | 4.4 | 3.9 | 4.5 | 4.4 |
| Degradation taste | 3.2 | 3.4 | 3.4 | 3.0 | 3.4 | 3.2 |
| Richness | 3.0 | 3.4 | 3.2 | 2.6 | 3.2 | 3.0 |

*Measured value

As a result, the same results as in test example 1 were also obtained using roasted corn oil as the heated/processed oil and fat.

### Test Example 3

Edible oil and fat compositions were prepared using the formulations shown in Table 5.

TABLE 5

| | Comparative | Example | Example | Comparative | Example | Example |
|---|---|---|---|---|---|---|
| | example 3-1 | 3-1 | 3-2 | example 3-2 | 3-3 | 3-4 |
| Edible oil and | 99.9995% | 99.9495% | 99.8995% | 99.9990% | 99.9490% | 99.8990% |
| fat (rapeseed | | | | | | |
| oil) | | | | | | |
| Chlorophyll(s) | 0.0005% | 0.0005% | 0.0005% | 0.0010% | 0.0010% | 0.0010% |
| Heated/processed | — | 0.0500% | 0.1000% | — | 0.0500% | 0.1000% |
| oil and fat A | | | | | | |
| Total | 100.0000% | 100.0000% | 100.0000% | 100.0000% | 100.0000% | 100.0000% |
| Chlorophyll(s) | 0.25 | 0.25 | 0.25 | 0.5 | 0.5 | 0.5 |
| [ppm]* | | | | | | |

*Measured value

A test of the changes over time in croquettes (evaluating only unpleasant taste) was conducted in the same manner as in test example 1.

TABLE 6

| | Comparative | Example | Example | Comparative | Example | Example |
|---|---|---|---|---|---|---|
| | example 3-1 | 3-1 | 3-2 | example 3-2 | 3-3 | 3-4 |
| Edible oil and | 99.9995% | 99.9495% | 99.8995% | 99.9990% | 99.9490% | 99.8990% |
| fat (rapeseed | | | | | | |
| oil) | | | | | | |
| Chlorophyll(s) | 0.0005% | 0.0005% | 0.0005% | 0.0010% | 0.0010% | 0.0010% |
| Heated/processed | — | 0.0500% | 0.1000% | — | 0.0500% | 0.1000% |
| oil and fat A | | | | | | |
| Chlorophyll(s) | 0.25 | 0.25 | 0.25 | 0.5 | 0.5 | 0.5 |
| [ppm]* | | | | | | |
| Unpleasant taste | 3.5 | 3.8 | 3.8 | 3.4 | 3.8 | 4.0 |

*Measured value

As a result, an effect of inhibiting unpleasant taste was found in the same manner as in test example 1 due to addition of a heated/processed oil and fat even in edible oil and fat compositions in which the chlorophyll content was 0.25 mass ppm.

### Test Example 4

Edible oil and fat compositions were prepared using the formulations shown in Table 7.

TABLE 7

| | Comparative | Example | Example | Comparative | Example | Example |
|---|---|---|---|---|---|---|
| | example 4-1 | 4-1 | 4-2 | example 4-2 | 4-3 | 4-4 |
| Edible oil and | 99.9995% | 99.5995% | 99.5995% | 99.9990% | 99.5990% | 99.5990% |
| fat (rapeseed | | | | | | |
| oil) | | | | | | |
| Chlorophyll(s) | 0.0005% | 0.0005% | 0.0005% | 0.0010% | 0.0010% | 0.0010% |
| Heated/processed | — | 0.4000% | — | — | 0.4000% | — |
| oil and fat A | | | | | | |
| Heated/processed | — | — | 0.4000% | — | — | 0.4000% |
| oil and fat B | | | | | | |
| Total | 100.0000% | 100.0000% | 100.0000% | 100.0000% | 100.0000% | 100.0000% |
| Chlorophyll(s) | 0.25 | 0.25 | 0.25 | 0.5 | 0.5 | 0.5 |
| [ppm]* | | | | | | |

*Measured value

A test of the changes over time in croquettes (evaluating only unpleasant taste) was conducted in the same manner as in test example 1.

TABLE 8

| | Comparative | Example | Example | Comparative | Example | Example |
|---|---|---|---|---|---|---|
| | example 4-1 | 4-1 | 4-2 | example 4-2 | 4-3 | 4-4 |
| Edible oil and | 99.9995% | 99.5995% | 99.5995% | 99.9990% | 99.5990% | 99.5990% |
| fat (rapeseed | | | | | | |
| oil) | | | | | | |
| Chlorophyll(s) | 0.0005% | 0.0005% | 0.0005% | 0.0010% | 0.0010% | 0.0010% |
| Heated/processed | — | 0.4000% | — | — | 0.4000% | — |
| oil and fat A | | | | | | |
| Heated/processed | — | — | 0.4000% | — | — | 0.4000% |
| oil and fat B | | | | | | |
| Chlorophyll(s) | 0.25 | 0.25 | 0.25 | 0.5 | 0.5 | 0.5 |
| [ppm]* | | | | | | |
| Unpleasant taste | 3.6 | 4.1 | 4.2 | 3.4 | 3.8 | 4.2 |

*Measured value

As a result, the same inhibitory effect on unpleasant taste as when the amount of heated/processed oil and fat A added was set at 0.4 mass % was found even when the amount of heated/processed oil and fat B added was 0.4 mass %.

### Test Example 5

Edible oil and fat compositions were prepared using the formulations shown in Table 9.

TABLE 9

| | Comparative | Example | Comparative | Example | Comparative | Example |
|---|---|---|---|---|---|---|
| | example 6-1 | 6-1 | example 6-2 | 6-2 | Example 6-3 | 6-3 |
| Edible oil and | 99.9980% | 99.5980% | — | — | — | — |
| fat (soybean oil) | | | | | | |
| Edible oil and | — | — | 99.9980% | 99.5980% | — | — |
| fat (corn oil) | | | | | | |
| Edible oil and | — | — | — | — | 99.9980% | 99.5980% |
| fat (IV67) | | | | | | |
| Chlorophyll(s) | 0.0020% | 0.0020% | 0.0020% | 0.0020% | 0.0020% | 0.0020% |
| Heated/processed | — | 0.4000% | — | 0.4000% | — | 0.4000% |
| oil and fat A | | | | | | |
| Total | 100.0000% | 100.0000% | 100.0000% | 100.0000% | 100.0000% | 100.0000% |
| Chlorophyll(s) | 1.4 | 1.4 | 1.4 | 1.4 | 1.4 | 1.4 |
| [ppm]* | | | | | | |

*Measured value

The heated/processed oil and fat A used in test example 1 was used as the heated/processed oil and fat. Instead of deodorized rapeseed oil, deodorized soybean oil (manufactured by J-Oil Mills, Inc.), deodorized corn oil (manufactured by J-Oil Mills, Inc.), or deodorized palm olein oil (manufactured by J-Oil Mills, Inc.) was used as the edible oil and fat.

A test of the changes over time in croquettes (evaluating only unpleasant taste) was conducted in the same manner as in test example 1.

TABLE 10

| | Comparative | Example | Comparative | Example | Comparative | Example |
|---|---|---|---|---|---|---|
| | example 6-1 | 6-1 | example 6-2 | 6-2 | Example 6-3 | 6-3 |
| Edible oil and | 99.9980% | 99.5980% | — | — | — | — |
| fat (soybean oil) | | | | | | |
| Edible oil and | — | — | 99.9980% | 99.5980% | — | — |
| fat (corn oil) | | | | | | |
| Edible oil and | — | — | — | — | 99.9980% | 99.5980% |
| fat (IV67) | | | | | | |
| Chlorophyll(s) | 0.0020% | 0.0020% | 0.0020% | 0.0020% | 0.0020% | 0.0020% |
| Heated/processed | — | 0.4000% | — | 0.4000% | — | 0.4000% |
| oil and fat A | | | | | | |
| Chlorophyll(s) | 1.4 | 1.4 | 1.4 | 1.4 | 1.4 | 1.4 |
| [ppm]* | | | | | | |
| Unpleasant taste | 3.5 | 3.8 | 3.6 | 4.0 | 3.8 | 4.0 |

*Measured value

As a result, an effect of inhibiting unpleasant taste was found in the same manner as in test example 1 due to addition of the heated/processed oil and fat even in edible oil and fat compositions that used deodorized soybean oil, deodorized corn oil, or deodorized palm olein oil.

### Test Example 6

Edible oil and fat compositions were prepared using the formulations shown in Table 11.

TABLE 11

| | Comparative | Example | Comparative | Example | Comparative | Example |
|---|---|---|---|---|---|---|
| | example 5-1 | 5-1 | example 5-2 | 5-2 | Example 5-3 | 5-3 |
| Edible oil and | 99.9980% | 99.5980% | — | — | — | — |
| fat (soybean oil) | | | | | | |
| Edible oil and | — | — | 99.9980% | 99.5980% | — | — |
| fat (corn oil) | | | | | | |
| Edible oil and | — | — | — | — | 99.9980% | 99.5980% |
| fat (IV67) | | | | | | |
| Chlorophyll(s) | 0.0020% | 0.0020% | 0.0020% | 0.0020% | 0.0020% | 0.0020% |
| Heated/processed | — | 0.4000% | — | 0.4000% | — | 0.4000% |
| oil and fat B | | | | | | |
| Total | 100.0000% | 100.0000% | 100.0000% | 100.0000% | 100.0000% | 100.0000% |
| Chlorophyll(s) | 1.4 | 1.4 | 1.4 | 1.4 | 1.4 | 1.4 |
| [ppm]* | | | | | | |

*Measured value

The heated/processed oil and fat B used in test example 2 was used as the heated/processed oil and fat. Instead of deodorized rapeseed oil, deodorized soybean oil (manufactured by J-Oil Mills, Inc.), deodorized corn oil (manufactured by J-Oil Mills, Inc.), or deodorized palm olein oil (manufactured by J-Oil Mills, Inc.) was used as the edible oil and fat.

A test of the changes over time in croquettes (evaluating only unpleasant taste) was conducted in the same manner as in test example 1.

TABLE 12

| | Comparative | Example | Comparative | Example | Comparative | Example |
|---|---|---|---|---|---|---|
| | example 5-1 | 5-1 | example 5-2 | 5-2 | Example 5-3 | 5-3 |
| Edible oil and | 99.9980% | 99.5980% | — | — | — | — |
| fat (soybean oil) | | | | | | |
| Edible oil and | — | — | 99.9980% | 99.5980% | — | — |
| fat (corn oil) | | | | | | |
| Edible oil and | — | — | — | — | 99.9980% | 99.5980% |
| fat (IV67) | | | | | | |
| Chlorophyll(s) | 0.0020% | 0.0020% | 0.0020% | 0.0020% | 0.0020% | 0.0020% |
| Heated/processed | — | 0.4000% | — | 0.4000% | — | 0.4000% |
| oil and fat B | | | | | | |
| Chlorophyll(s) | 1.4 | 1.4 | 1.4 | 1.4 | 1.4 | 1.4 |
| [ppm]* | | | | | | |
| Unpleasant taste | 2.8 | 3.6 | 3.8 | 4.2 | 2.8 | 3.0 |

*Measured value

As a result, an effect of inhibiting unpleasant taste was found in the same manner as in test example 1 due to addition of the heated/processed oil and fat even in edible oil and fat compositions that used deodorized soybean oil, deodorized corn oil, or deodorized palm olein oil.

1. An edible oil and fat composition characterized by containing:
(A) a chlorophyll including one or more selected from the group consisting of chlorophyll a, pheophytin a, and pyropheophytin a;
(B) a heated/processed oil and fat including one or more oils selected from the group consisting of (b1) a first heated oil obtained by heat-treating an unrefined raw oil including one or more oils selected from the group consisting of a pressed oil from an oil and fat material and an extracted oil from the oil and fat material, or an oil and fat that has passed through one or more steps selected from the group consisting of a degumming step, a deacidification step, and a decolorization step in a step for refining the unrefined raw oil, (b2) a roasted oil obtained by pressing or extracting the oil and fat material, which has been roasted, and (b3) a second heated oil obtained by heat-treating an oil and fat containing the oil and fat material and/or a processed product thereof; and
(C) an edible oil and fat.

2. The edible oil and fat composition according to claim 1, containing 0.05 mass ppm or more and 2.00 mass ppm or less of the (A) chlorophyll and 0.05 mass % or more and 10.0 mass % or less of the (B) heated/processed oil and fat.

3. The edible oil and fat composition according to claim 1, wherein the mass ratio of the (B) heated/processed oil and fat to the (A) chlorophyll is 1:200-1:250000.

4. The edible oil and fat composition according to claim 1, wherein the oil and fat material of the (B) heated/processed oil and fat includes one or more materials selected from the group consisting of corn, soybeans, and rapeseed.

5. The edible oil and fat composition according to claim 1, containing one or more oils selected from the group consisting of rapeseed oil, soybean oil, corn oil, and palm olein as the (C) edible oil and fat.

6. The edible oil and fat composition according to claim 1, wherein the (b1) first heated oil has been heat-treated at 120° C. or more, the (b2) roasted oil has been subjected to a roasting treatment at 90° C. or more and 180° C. or less, and the (b3) second heated oil has been subjected to a heat treatment under conditions that satisfy formula (1) below, with a heating time of 5 minutes or more and 240 minutes or less at more than 100° C. and 220° C. or less.
85−6000/(270−T)<t<240 (1)
(where T: heating temperature (° C.), and t: heating time (minutes); if 85−6000/(270−T) yields a negative value, “5” is to be used)

7. A method for inhibiting unpleasant taste in a food cooked using a chlorophyll-containing oil and fat composition, characterized in that the method comprises a step in which an edible oil and fat composition containing (A) a chlorophyll including one or more selected from the group consisting of chlorophyll a, pheophytin a, and pyropheophytin a and (C) an edible oil and fat has added thereto and mixed therewith (B) a heated/processed oil and fat including one or more oils selected from the group consisting of (b1) a first heated oil obtained by heat-treating an unrefined raw oil including one or more oils selected from the group consisting of a pressed oil from an oil and fat material and an extracted oil from the oil and fat material, or an oil and fat that has passed through one or more steps selected from the group consisting of a degumming step, a deacidification step, and a decolorization step in a step of refining the unrefined raw oil, (b2) a roasted oil obtained by pressing or extracting the oil and fat material that has been roasted, and (b3) a second heated oil obtained by heat-treating an oil and fat containing the oil and fat material and/or a processed product thereof.

8. An agent for inhibiting unpleasant taste in a food cooked using a chlorophyll-containing oil and fat composition, characterized in that the agent contains as an active ingredient (B) a heated/processed oil and fat including one or more oils selected from the group consisting of (b1) a first heated oil obtained by heat-treating an unrefined raw oil including one or more oils selected from the group consisting of a pressed oil from an oil and fat material and an extracted oil from the oil and fat material, or an oil and fat that has passed through one or more steps selected from the group consisting of a degumming step, a deacidification step, and a decolorization step in a step of refining the unrefined raw oil, (b2) a roasted oil obtained by pressing or extracting the oil and fat material, which has been roasted, and (b3) a second heated oil obtained by heat-treating an oil and fat containing the oil and fat material and/or a processed product thereof.

9. A method for producing a deep-fried food, characterized in that a food ingredient is oil-fried using the edible oil and fat composition according to claim 1.
